(19) United States
(12) Patent Application Publication
(10) Pub. No.: US 2002/0182036 A1
(43) Pub. Date: Dec. 5, 2002

(54) Semiconductor wafer handling robot for linear transfer chamber

(75) Inventor: Robert B. Lowrance, Los Gatos, CA (US)

Correspondence Address: APPLIED MATERIALS, INC., 2881 SCOTT BLVD. M/S 2061, SANTA CLARA, CA, 95050, US

(73) Assignee: Applied Materials, Inc.

(21) Appl. No.: 09/874,169

(22) Filed: Jun. 4, 2001

(51) Int. Cl. B65G 49/07

(52) U.S. Cl. 414/217

(57) ABSTRACT

A wafer-handling robot is installed in a linear transfer chamber. The robot includes two cars mounted to travel along a linear guide. A first arm is pivotally mounted on the first car and a second arm is pivotally mounted on the second car. A robot wrist is pivotally mounted on outer ends of the two arms. When the cars are driven toward each other, the robot wrist is extended away from the linear guide. When the cars are driven away from each other, the robot wrist is retracted toward the linear guide.

### FIELD OF THE INVENTION

The present invention relates to an apparatus for transferring objects, and is more particularly related to such an apparatus that is suitable for use in a linear transfer chamber.

### BACKGROUND OF THE INVENTION

Semiconductor fabrication practices generally call for a number of processes to be performed on a substrate such as a silicon wafer. Such process may include thin film deposition, etching, heat treatment, photolithography, and so forth. Typically, each process is performed in a separate processing chamber which is dedicated to the particular process.

It is well known to arrange a number of processing chambers around a common transfer chamber. According to conventional practice, a wafer-handling robot is disposed in the transfer chamber to transport substrates from one processing chamber to another.

To minimize the risk of contamination of the substrates, it is customary to maintain a vacuum in the transfer chamber. To minimize the risk of particulate contamination, prior art wafer-handling robots have been arranged so that all motors are positioned outside of the transfer chamber, in an adjoining space (which may be at atmospheric pressure). The motors are coupled by pairs of magnets through the wall of the transfer chamber to moving parts of the wafer-handling robot inside the transfer chamber.

Most transfer chambers are round and wide, and require metal parts that are quite large and are quite expensive to fabricate. Moreover, the wafer-handling robots employed in such transfer chambers are complicated and expensive to manufacture. It would be desirable to provide a transfer chamber and associated wafer-handling robot that are simple, inexpensive to manufacture, and arranged to minimize risks of particulate contamination.

### SUMMARY OF THE INVENTION

According to the invention, an apparatus adapted to transport a substrate is provided. The apparatus includes a first linear guide, a first car adapted to travel along the first linear guide, and a second car adapted to travel along the first linear guide. The apparatus further includes a first arm having a first end pivotally mounted on the first car and having a second end. Further included in the apparatus is a second arm having a first end pivotally mounted on the second car and having a second end. Also included in the apparatus is a substrate support member connected to the second end of the first arm by a first pivot and connected to the second end of the second arm by a second pivot. The first car and the second car may be moved toward each other to move the substrate support member from a retracted position to an extended position. The first car and the second car may be moved away from each other to move the substrate support member from an extended position to a retracted position.

The apparatus may further include a drive mechanism adapted to drive the first car and the second car along the first linear guide. The first car may have a first magnet adapted to magnetically couple the first car to the drive mechanism, and the second car may have a second magnet adapted to magnetically couple the second car to the drive mechanism. The drive mechanism may include a second linear guide mounted below the first linear guide. The drive mechanism may further include a first drive car adapted to travel along the second linear guide and magnetically coupled to the first car, and a second drive car adapted to travel along the second linear guide and magnetically coupled to the second car.

The first linear guide may be positioned in a vacuum chamber and the second linear guide may be positioned outside the vacuum chamber. The first linear guide may be a first shaft having a circular cross-section, and the second linear guide may be a second shaft or pair of shafts having a circular cross-section, although other cross sections may be employed. The first car may have a pair of wheels engaging the first shaft, and the second car may have a pair of wheels engaging the first shaft.

The present invention thus provides a wafer-handling robot that is suitable for use in a linear transfer chamber that is lined with processing chambers. A linear transfer chamber may be formed by extrusion, which is a much less expensive process than fabrication of the monolithic structures required for round transfer chambers. Furthermore, the design of the wafer-handling robot is simple and includes a minimum of moving parts. Also, all motors for moving the wafer-handling robot are positioned outside of the transfer chamber in an adjacent area which is sealed off from the transfer chamber, thereby minimizing the risk of particulate contamination from the motors. In general, the design of the wafer-handling robot is such as to minimize generation of particles. Thus the linear transfer chamber with the wafer-handling robot provided in accordance with the invention allows for a semiconductor processing facility that is relatively inexpensive to manufacture and achieves a high degree of freedom from particulate contaminants.

Further features and advantages of the present invention will become more fully apparent from the following detailed description of the preferred embodiments, the appended claims and the accompanying drawings.

### BRIEF DESCRIPTION OF THE DRAWINGS

FIG. 1 is a schematic plan view showing a portion of a semiconductor processing facility having installed therein a wafer-handling robot provided in accordance with an embodiment of the invention, the wafer-handling robot being shown in an extended position;

FIG. 2 is a view similar to FIG. 1, showing the wafer-handling robot in a retracted position;

FIG. 3 is a cross-sectional view taken at line III-III of FIG. 2, showing details of a car that is part of the wafer-handling robot, and also showing a portion of a drive mechanism for the wafer-handling robot;

FIG. 4 is a side view showing a car of the wafer-handling robot, and a corresponding drive car that is part of the drive mechanism for the wafer-handling robot; and

FIG. 5 is a plan view showing details of a robot wrist that is part of the wafer-handling robot of FIG. 1.

### DESCRIPTION OF A PREFERRED EMBODIMENT

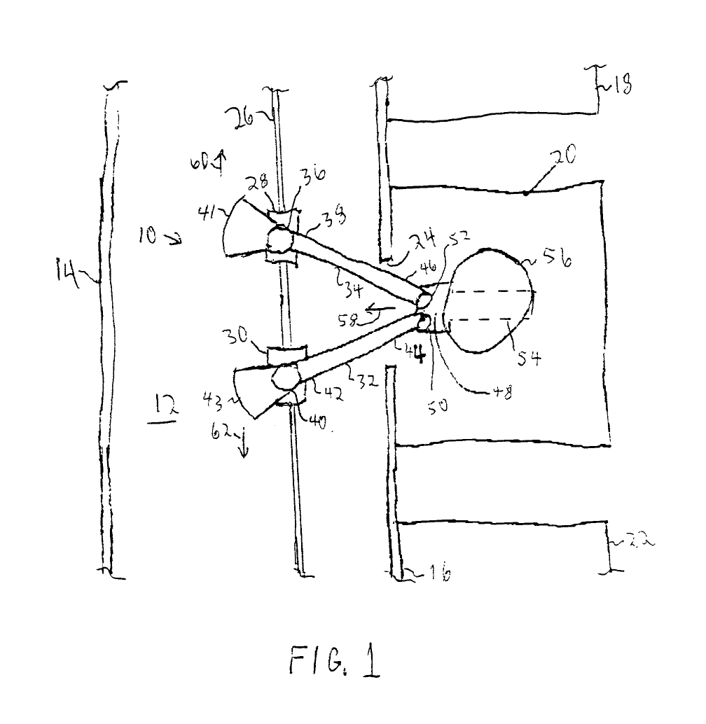

FIG. 1 is a plan view that shows a wafer-handling robot 10 provided in accordance with the invention. The wafer-handling robot 10 is shown in an extended position in FIG. 1. The robot 10 is installed in a transfer chamber 12. The transfer chamber 12 has a linear configuration and includes an enclosure defined by side walls 14 and 16 and other walls (not shown in FIG. 1) of the transfer chamber.

Processing chambers 18, 20, 22 are arranged along the side wall 16 of the transfer chamber 12. The processing chambers may be used for conventional semiconductor fabrication processes such as thin film deposition, etching, thermal processing and so forth. Although only three processing chambers are shown in FIG. 1, the number of processing chambers may be larger. For example, six processing chambers may be provided along side wall 16 of transfer chamber 12. Other facilities, such as one or more loadlocks (not shown) may also be provided adjacent any side of the transfer chamber 12.

Each processing chamber includes an opening or slit valve 24 (only one shown in FIG. 1) through which a wafer may be loaded into or removed from the processing chamber.

A linear guide shaft or monorail 26 is installed along the length of the transfer chamber 12. The wafer-handling robot 10 includes cars 28 and 30 that are mounted on the monorail 26 and are adapted to travel therealong. The robot 10 further includes arms 32, 34. Arms 32, 34 are of substantially equal length. Arm 34 is mounted to car 28 by a pivot 36 at a first end 38 of the arm 34. Arm 32 is mounted to car 30 by pivot 40 at first end 42 of arm 32. Counterweights 41, 43 are respectively mounted on pivots 36, 40 and respectively extend in opposite directions to arms 34, 32 to counter-balance downward moments exerted by arms 34, 32 and the load supported by arms 34, 32. Arm 32 has a second end 44 and arm 34 has a second end 46. A robot wrist 48 is mounted to the second end 44 of the arm 32 by a pivot 50. The robot wrist 48 is also mounted to the second end 46 of the arm 34 by a pivot 52. A wafer support blade 54 extends horizontally outwardly from the robot wrist 48. A wafer 56 is supported on the wafer support blade 54. The arms 32, 34 and the pivots 36, 40, 50, 52 collectively constitute a linkage that couples robot wrist 48 to the cars 28, 30.

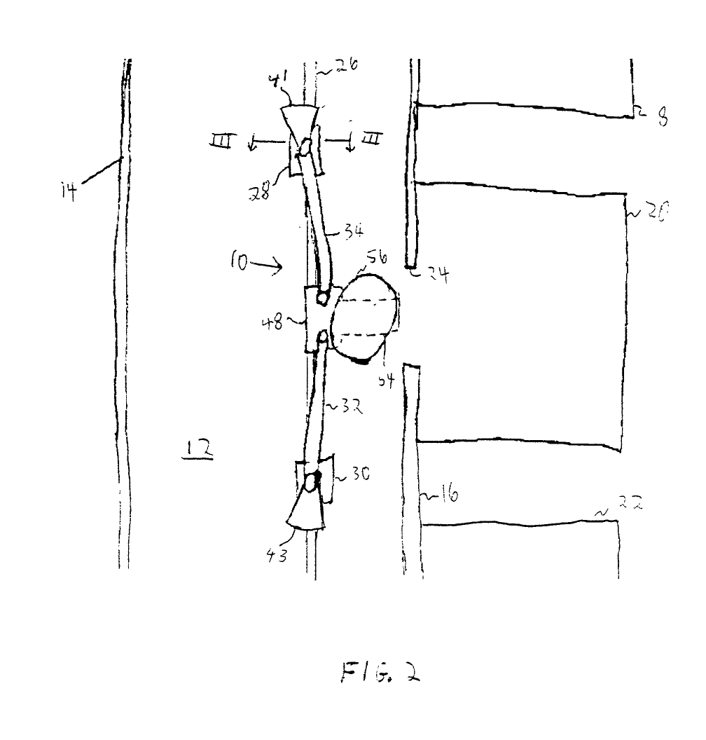

To retract the robot wrist 48 (arrow 58 indicates retracting motion of the robot wrist 48), the cars 28 and 30 are moved away from each other, as indicated by arrows 60 and 62. As a consequence of this motion, the robot 10 assumes the retracted position shown in FIG. 2. It will be observed that the wafer 56 has been withdrawn from the processing chamber 20 via the slit valve 24. To move the robot 10 (and robot wrist 48) from the retracted position to the extended position (so as to load a wafer 56 into a processing chamber) the cars 28 and 30 are moved towards each other. To translate the robot 10 (and a wafer 56 carried by the robot 10) along the monorail 26, both cars 28 and 30 are moved along the monorail 26 in the same direction and at the same speed. It will be appreciated that translation of the robot 10 only occurs with the robot 10 and robot wrist 48 are retracted from the processing chambers (e.g., in the retracted position of FIG. 2).

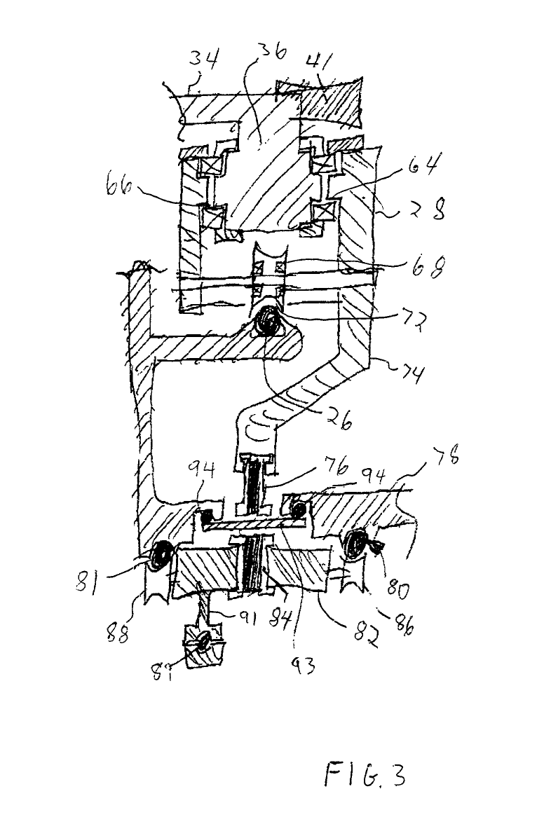

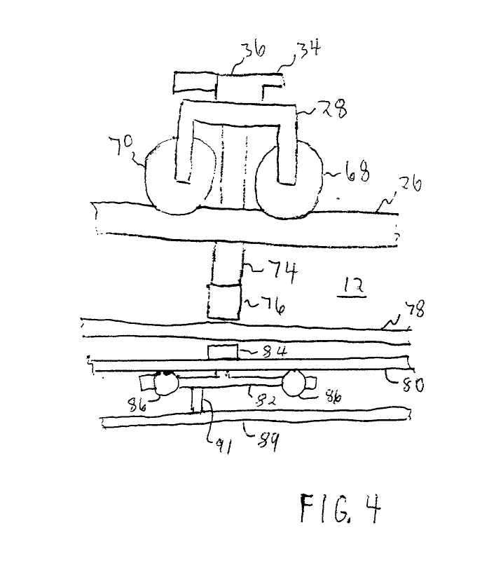

FIG. 3 is a cross-sectional view taken at line III-III of FIG. 2, and showing details of car 28 and aspects of a drive mechanism for the robot 10. FIG. 4 is a side view showing details of car 28 and aspects of the drive mechanism.

FIG. 3 shows that car 28 mounts pivot 36 for arm 34 on bearings 64, 66. Wheels 68, 70 (FIG. 4) of car 28 contact monorail 26. The wheels 68, 70 have an inner radius (represented by inner radius 72 of wheel 68, FIG. 3) which is greater than the cross-sectional radius of monorail 26. Consequently, wheels 68, 70 are seated on monorail 26.

In the embodiment shown, a magnet supporting member 74 extends downwardly from the car 28, around and below monorail 26. A magnet 76 is held by the magnet support member 74 underneath the monorail 26 and adjacent and above floor 78 of transfer chamber 12.

Guide shafts 80, 81 are mounted below the floor 78 of the transfer chamber 12. The space in which the guide shafts 80, 81 are mounted may be at atmospheric pressure, whereas a vacuum may be maintained in the transfer chamber 12 during transfer and processing operations.

The guide shafts 80, 81 run parallel to, coextensively with, and below the monorail 26 on which the cars 28 and 30 travel. A drive car 82 travels along guide shafts 80, 81. The drive car 82 is positioned directly underneath car 28. Car 82 has mounted thereon a magnet 84. The magnet 84 is positioned adjacent to and immediately below the floor 78 of the transfer chamber 12. The magnets 76 and 84 are magnetically coupled with each other, so that, as car 82 moves along guide shafts 80, 81 car 28 is driven by car 82 along monorail 26. Wheels 86, 88 of drive car 82 are respectively, in contact with guide shafts 80, 81. A motor, which is not shown, may be mounted on the drive car 82 to drive one or both of the wheels 86, 88. Alternatively, the drive car 82 may be driven by a belt, band or cable 89 that is threaded through a fixed pulley (not shown) and driven by a fixed rotary motor (not shown) or linear motor (not shown). The drive car 82 may be coupled to the belt 89 by a clamp 91.

It will be appreciated that a second drive car (not shown) travels on the guide shafts 80, 81 and is positioned immediately below and magnetically coupled to car 30 of robot 10. The drive car 82 is moved along guide shafts 80, 81 so as to drive car 28 along the first monorail 26, and the second drive car, which is not shown, is moved along the guide shafts 80, 81 so as to drive car 30 along monorail 26. Car 30 may be substantially identical to car 28, and the arrangement of the second drive car relative to car 30 may be substantially the same as the arrangement shown in FIGS. 3 and 4.

With this arrangement, the motors required to translate, extend and retract the wafer-handling robot 10 are positioned outside of the transfer chamber 12, and therefore are not a potential source of particulate contamination in the transfer chamber 12. Furthermore, in the embodiment shown, each wheel of the robot cars 28, 30 is arranged to have a single point of contact with the monorail 26. Also, the magnet 76 of the robot car 28 is mounted directly underneath the monorail 26 so that there is no sideways moment of force imparted by the coupling with the drive car 82. It will be appreciated that robot car 30 is similarly arranged. The avoidance of sideways moments, and the provision of a single point of contact wheel-to-shaft, aids in avoiding particulate contamination.

The portion of the transfer chamber floor 78 through which the robot car magnets couple to the drive car magnets is preferably constituted by a stainless steel insert 93 to avoid eddy currents. The stainless steel insert is installed with suitable seals 94 in the floor 78 of the transfer chamber 12. The body of the transfer chamber 12 may be formed of extruded aluminum.

Instead of the single magnets 76, 84 shown respectively on the robot car 28 and the drive car 82, respective linear arrays of magnets may be provided on the cars.

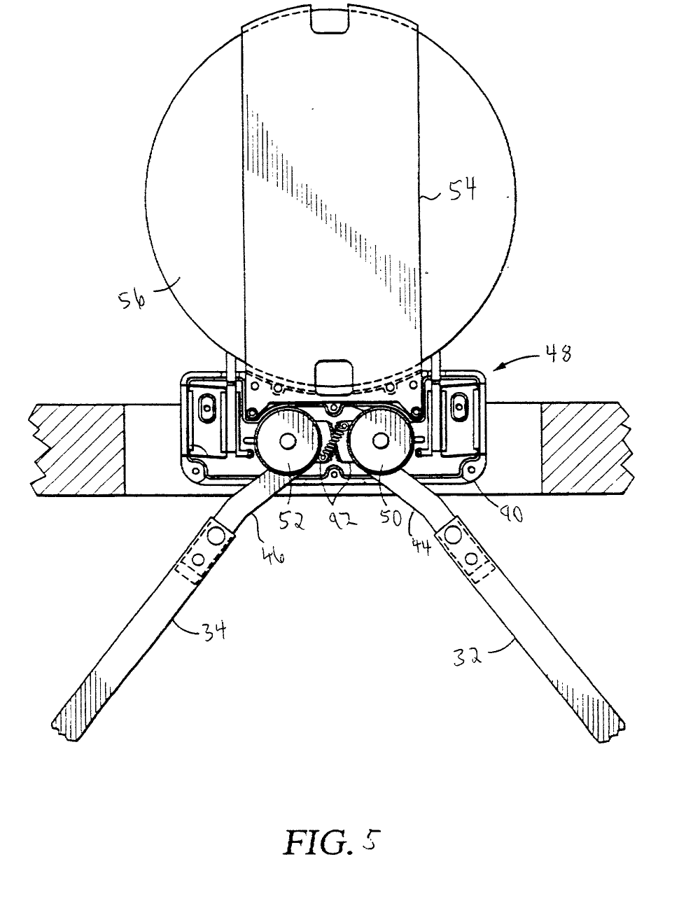

Referring now to FIG. 5, certain details of an embodiment of the robot wrist 48 will be described. The robot wrist 48 includes a wrist housing 90 into which the ends 44, 46 of arms 32, 34 extend. The pivots 50, 52 on the wrist 48 each include a toothed intermeshed gear 92. The toothed gears 92 of the pivots 50, 52 are intermeshed to provide controlled movement of the blade 54 so that the blade 54 always extends perpendicularly relative to the monorail 26, without wobbling or becoming cocked sideways. Other methods of providing controlled movement of the blade 54 may also be employed within the scope of the present invention.

The wafer-handling robot 10 may be operated in three modes: a translation mode, an extension mode, and a retraction mode. In the translation mode, the two drive cars are moved in the same direction along the guide shaft 80 at the same speed. The robot cars 28 and 30 which are magnetically coupled, respectively, to the two drive cars, move along the monorail 26. The robot 10, and any wafer 56 mounted on the wafer support blade 54, thus are translated along the length of the transfer chamber 12. The wafer-handling robot 10 is operated in the translation mode only when it is in a retracted position such as that shown in FIG. 2.

In the extension mode, the robot wrist 48 is moved from the retracted position (FIG. 2) to the extended position (FIG. 1). To accomplish this, the drive cars are moved towards each other, thereby moving the robot cars 28, 30 towards each other along the monorail 26. As the distance between the robot cars 28, 30 is reduced, the robot wrist 48, the wafer support blade 54, and any wafer 56 on the wafer support blade 54, are all moved perpendicularly away from the monorail 26 and into one of the processing chambers.

In the retraction mode, the robot wrist 48 is moved from the extended position (FIG. 1) to the retracted position (FIG. 2). To accomplish this, the drive cars are moved away from each other along the second guide shaft 80. The robot cars 28 and 30, which are coupled to the drive cars, thus are also moved away from each other, along monorail 26. As the distance between the robot cars 28, 30 increases, the robot wrist 48, the wafer support blade 54, and any wafer 56 that is held on the wafer support blade 54, are all drawn toward the monorail 26, and out of and away from a processing chamber.

The wafer-handling robot provided in accordance with the present invention is simple and relatively inexpensive to manufacture, and may be arranged to minimize the likelihood of particulate contamination. Furthermore, the inventive wafer-handling robot accommodates use of a linear transfer chamber, which may be manufactured at lower cost than conventional round transfer chambers.

The foregoing description discloses only a preferred embodiment of the invention; modifications of the above disclosed apparatus which fall within the scope of the invention will be readily apparent to those of ordinary skill in the art. For instance, it is contemplated to drive the cars 28, 30 by arrangements other than the drive cars positioned below the transfer chamber. As one example, linear motors may be provided within the transfer chamber for the cars 28, 30. It is also contemplated that drive cars might be provided in a side-by-side arrangement relative to the cars 28, 30, so that the cars 28, 30 are magnetically coupled to respective drive cars through the side wall 14 of the transfer chamber 12 or might be provided above the cars 28, 30, to magnetically couple thereto through the ceiling of the transfer chamber 12.

Furthermore, in the embodiment of the invention disclosed herein, the robot wrist 48 is extended and retracted in a horizontal direction. However, it is also contemplated to extend or retract the robot wrist 48 in a vertical direction by moving cars 28, 30 toward or away from each other respectively. Accordingly, the wafer-handling robot of the present invention may be modified to provide vertical motion in lieu of horizontal motion perpendicular to the monorail.

While the present invention has been disclosed in connection with preferred embodiments thereof, it should be understood that other embodiments may fall within the spirit and scope of the invention, as defined by the following claims.

The invention claimed is:

1. An apparatus adapted to transport a substrate, comprising:
a first linear guide;
a first car adapted to travel along the first linear guide;
a second car adapted to travel along the first linear guide;
a first arm having a first end pivotally mounted on the first car and having a second end;
a second arm having a first end pivotally mounted on the second car and having a second end; and
a substrate support member connected to the second end of the first arm by a first pivot and connected to the second end of the second arm by a second pivot.

2. The apparatus of claim 1, wherein:
the first car and the second car are moved toward each other to move the substrate support member from a retracted position to an extended position; and
the first car and the second car are moved away from each other to move the substrate support member from an extended position to a retracted position.

3. The apparatus of claim 1, further comprising a drive mechanism adapted to drive the first car and the second car along the first linear guide, the first car having a first magnet adapted to magnetically couple the first car to the drive mechanism, the second car having a second magnet adapted to magnetically couple the second car to the drive mechanism.

4. The apparatus of claim 3, wherein the drive mechanism includes a second linear guide mounted below the first linear guide, a first drive car adapted to travel along the second linear guide and magnetically coupled to the first car, and a second drive car adapted to travel along the second linear guide and magnetically coupled to the second car.

5. The apparatus of claim 4, wherein the first linear guide is positioned in a vacuum chamber and the second linear guide is positioned outside the vacuum chamber.

6. The apparatus of claim 4, wherein the first linear guide includes a first shaft having a circular cross-section and the second linear guide includes a second shaft having a circular cross-section.

7. The apparatus of claim 1, wherein the first linear guide includes a shaft having a circular cross section.

8. The apparatus of claim 7, wherein the first car has a pair of wheels engaging the shaft and the second car has a pair of wheels engaging the shaft.

9. The apparatus of claim 1, wherein the arms are of substantially equal length.

10. The apparatus of claim 1, wherein the substrate support member includes a substrate support blade.

11. A method of operating a substrate-handling robot, comprising the steps of:
moving two cars towards each other on a linear guide to extend a robot wrist mounted by a linkage to the two cars; and
moving the two cars away from each other on the linear guide to retract the robot wrist.

12. The method of claim 11, further comprising translating the robot wrist along the linear guide by moving the two cars in the same direction along the linear guide.

13. The method of claim 11, wherein the steps of moving the two cars include driving the two cars with a drive mechanism that is magnetically coupled to the two cars.

14. The method of claim 11, wherein the steps of moving the two cars cause the robot wrist to move horizontally.

15. An apparatus adapted to transport a substrate, comprising:
a linear guide;
a first car adapted to travel along the linear guide;
a second car adapted to travel along the linear guide;
a substrate support member; and
a linkage mounting the substrate support member on the first and second cars so that the substrate support member is moved to an extended position when the cars are moved towards each other and the substrate support member is moved to a retracted position when the cars are moved away from each other.

16. The apparatus of claim 15, further comprising a drive mechanism that is magnetically coupled to the first car and the second car.

17. The apparatus of claim 15, wherein the linkage includes a pair of arms, each arm pivotally mounted to a respective one of the first car and the second car.

18. A system for manufacturing semiconductors, comprising:
a transfer chamber;
a linear guide installed in the transfer chamber;
a first car adapted to travel along the linear guide;
a second car adapted to travel along the linear guide;
a first arm having a first end pivotally mounted on the first car and having a second end;
a second arm having a first end pivotally mounted on the second car and having a second end; and
a substrate support member connected to the second end of the first arm by a first pivot and connected to the second end of the second arm by a second pivot.

19. A transfer chamber, comprising:
an enclosure;
a linear guide installed in the enclosure;
a first car adapted to travel along the linear guide;
a second car adapted to travel along the linear guide;
a first arm having a first end pivotally mounted on the first car and having a second end;
a second arm having a first end pivotally mounted on the second car and having a second end; and
a substrate support member connected to the second end of the first arm by a first pivot and connected to the second end of the second arm by a second pivot.

20. A robot, comprising:
a linear guide;
a first car adapted to travel along the linear guide;
a second car adapted to travel along the linear guide;
a first arm having a first end pivotally mounted on the first car and having a second end;
a second arm having a first end pivotally mounted on the second car and having a second end; and
a substrate support member connected to the second end of the first arm by a first pivot and connected to the second end of the second arm by a second pivot.
